(19) United States
(12) Patent Application Publication
(10) Pub. No.: US 2015/0005124 A1
(43) Pub. Date: Jan. 1, 2015

(54) V-BELT FOR HIGH LOAD TRANSMISSION

(71) Applicant: BANDO CHEMICAL INDUSTRIES, LTD., Kobe-shi (JP)

(72) Inventor: Hiroyuki Sakanaka, Kobe-shi (JP)

(21) Appl. No.: 14/491,078

(22) Filed: Sep. 19, 2014

Related U.S. Application Data
(63) Continuation of application No. PCT/JP2013/001847, filed on Mar. 18, 2013.

(30) Foreign Application Priority Data
Mar. 19, 2012 (JP) 2012-061594

(51) Int. Cl. F16G 5/16

(52) U.S. Cl. CPC F16G 5/16
USPC 474/242

(57) ABSTRACT

A V-belt for high load transmission reduces the temporal change in belt tension according to a change in a thrust-tension conversion ratio from an initial running stage. For this purpose, the side surfaces of each tension band and blocks in a belt width direction form sliding surface abutting on the groove surface of a pulley. An area S1 of the sliding surface of the tension band and an area S2 of the sliding surface of each of the blocks satisfy a relationship of S1/S2≦0.2 (i.e., the area S1 of the sliding surface of the tension band is 20% or smaller of the area S2 of the sliding surface of each of the blocks).

### CROSS-REFERENCE TO RELATED APPLICATIONS

This is a continuation of International Application No. PCT/JP2013/001847 filed on Mar. 18, 2013, which claims priority to Japanese Patent Application No. 2012-061594 filed on Mar. 19, 2012. The entire disclosures of these applications are incorporated by reference herein.

### BACKGROUND

The present disclosure relates to V-belts for high load transmission, and more particularly to those preferably used for belt-type continuously variable transmissions.

This type of V-belts for high load transmission have been well known, and, for example, have been wound between variable speed pulleys of belt-type continuously variable transmissions. Each V-belt for high load transmission includes tension bands, each having numbers of, for example, upper and lower recessed grooves arranged at regular intervals in the upper surface facing the back of the belt and the lower surface facing the bottom of the belt in the belt length direction to vertically correspond to each other. Each V-belt also includes numbers of blocks, each including fit portions in which the tension bands are press-fitted, for example, an upper projecting tooth formed in the upper surfaces of the fit portions and meshing with the upper grooves of the tension bands, and, for example, a lower projecting tooth formed in the lower surfaces of the fit portions and meshing with the lower grooves of the tension bands. The V-belts are also called block belts.

Each tension band includes a cord reducing expansion of the belt and transmitting power, a shape-retaining rubber layer, a canvas reducing friction with the blocks, etc.

The blocks are made of resin such as phenolic resin. Each block includes an upper beam at the back of the belt, and a lower beam at the bottom of the belt. The fit portions of the tension bands are formed between the upper and lower beams.

The tension bands are press-fitted in the fit portions of the blocks, thereby engaging the blocks with the tension bands, with the projecting teeth and the recessed grooves meshing at regular intervals in the belt length direction. The teeth of the blocks and the grooves of the tension bands are integrated by the meshing to transmit power.

Such a V-belt for high load transmission provides a protruding margin, which is the protrusion of the outer end surface of each tension band in the width direction beyond the contact surfaces of the blocks with a pulley (see, e.g., for example, Japanese Patent No. 4256498). Then, when the belt is wound around the pulley, the protruding margin of the tension band is pressed inside in the belt width direction such that the tension band vertically expands in the fit portions. As a result, the blocks are firmly held by the tension band. In such a V-belt for high load transmission, the side surfaces of the blocks and the tension band in the belt width direction abut on the groove surface of the pulley.

### SUMMARY

The present inventor found the following phenomenon in the above-described V-belt for high load transmission. When the belt is wound around a variable speed pulley to run, the thrust applied from the groove surface of the pulley to the contact surface of the belt with the pulley generates the belt tension. As the running time passes from the initial running stage of the belt, the thrust-tension conversion ratio changes. If the thrust-tension conversion ratio changes, desired belt tension may not be obtained.

In order to secure desired belt tension in a long running period of the belt, a drive unit opening and closing the variable speed pulley is suggested to have excessive thrust including a safety factor to some extent. This increases the load applied to the belt to deteriorate the durability and increase noise.

The present disclosure aims to provide a V-belt for high load transmission, which reduces a temporal change in the belt tension according to a change in the thrust-tension conversion ratio from the initial running stage of the belt, not requiring the excessive thrust.

The present inventor studied the phenomenon of the change in the thrust-tension conversion ratio, and found that the change is generated by the following two mechanisms.

Specifically, in the V-belts for high load transmission, the resin which is the component of the blocks has a higher coefficient of thermal expansion than the rubber which is the component of each tension band. When the belt is wound around the variable speed pulley to run, due to the thermal expansion of the tension band, the lower beams of the blocks are bound to the tension band, and are not pushed up. However, the upper beams are pushed up to increase the distance between the upper and lower beams. The side surfaces of the lower beams mainly abut on the groove surface of the pulley. This reduces the thrust-tension conversion ratio to reduce the belt tension.

After that, when the tension band is fatigued with the running of the belt, the expansion of the upper beams decreases, and the side surfaces of the upper beams also abut on the groove surface of the pulley. As a result, the thrust-tension conversion ratio increases to increase the belt tension. As such, the thrust-tension conversion ratio changes as the running time passes from the initial running stage of the belt.

The other mechanism is caused by the dependency of the thrust-tension conversion ratio on the coefficient of friction of the belt. Specifically, when the belt is wound around the variable speed pulley to run, the thermal expansion of the tension band increases the ratio of the tension band to the contact surface of the belt with the pulley. Since the tension band (i.e., rubber) has a higher coefficient of friction than the blocks (i.e., resin), the coefficient of friction of the belt as a whole increases with the increasing the ratio of the tension band. As a result, the thrust-tension conversion ratio increases to increase the belt tension.

After that, when the tension band is worn in accordance with the running of the belt, the ratio of the tension band to the contact surface of the belt with the pulley decreases to decrease the coefficient of friction of the belt as a whole. As a result, the thrust-tension conversion ratio decreases to decrease the belt tension.

These two mechanisms change the thrust-tension conversion ratio as the running time passes from the initial running stage of the belt. The present inventor focused on reducing the influence of the thermal expansion of the tension band, which is common between these two mechanisms, and completed the present disclosure.

Specifically, the present disclosure provides a V-belt for high load transmission including tension bands, each including a cord buried inside a shape-retaining rubber layer, and numbers of upper and lower grooves arranged in a belt length direction to vertically correspond to each other, the upper grooves being formed in an upper surface facing a back of the belt, and the lower grooves being formed in a lower surface facing a bottom of the belt; and numbers of blocks, each including fit portions in which the tension bands are press-fitted, an upper tooth formed in upper surfaces of the fit portions and meshing with the upper grooves of the tension bands, and a lower tooth formed in lower surfaces of the fit portions and meshing with the lower grooves of the tension bands. The tension bands are fitted in the fit portions of the blocks, thereby engaging and fixing the blocks with and to the tension bands. Meshing of the teeth of the blocks with the grooves of the tension bands transmits power.

Side surfaces of each tension band and the blocks in a belt width direction form sliding surfaces abutting on a groove surface of a pulley.

An area S1 of the sliding surface of the tension band and an area S2 of the sliding surface of each of the blocks satisfy a relationship of S1/S2≦0.2 (i.e., the area of the side surface of the tension band is 20% or smaller of the area of the side surface of each block).

A ratio S1/S2 of the area S1 of the sliding surface of the tension band to the area S2 of the sliding surface of each of the blocks may range from 0.13 to 0.2.

The area S1 of the sliding surface of the tension band may range from 4.3 to 8.5 mm². The area S2 of the sliding surface of each of the blocks may range from 33 to 43 mm².

This structure provides the following effects and advantages. If the ratio S1/S2 of the area S1 of the sliding surface of the tension band to the area S2 of the sliding surface of each of the blocks is higher than 0.2, the ratio of the tension band to the contact surface of the belt with the pulley is high. Then, the tension band thermally expands to push up the upper beams of the blocks, and increase the coefficient of friction of the belt. However, in the present disclosure, the ratio S1/S2 of the area S1 of the sliding surface of the tension band to the area S2 of the sliding surface of each of the blocks is 0.2 or smaller. That is, the ratio of the tension band to the contact surface of the belt with the pulley is sufficiently low. Thus, the upper beams of the blocks are not pushed up by the thermal expansion of the tension band, and an increase in the coefficient of friction of the belt is reduced. This reduces the change in the thrust-tension conversion ratio and the change in the belt tension according thereto with the running time of the belt. As a result, the thrust of the drive unit decreases to reduce the initial heat built-up of the belt, and to improve the efficiency and the durability of the belt.

A belt pitch width a being a belt width at a position of the cord of each tension band, and a meshing thickness b of the tension band between lower ends of the upper grooves and upper ends of the lower grooves satisfy a relationship of b/a≦0.08.

This structure reduces bending loss of the belt. This further reduces the change in the thrust-tension conversion ratio with the running time of the belt.

Furthermore, the belt pitch width a and the meshing thickness b of the tension band may satisfy a relationship of b/a≦0.05.

This structure significantly reduces the bending loss of the belt, and more effectively reduces the change in the thrust-tension conversion ratio with the running time of the belt.

The V-belt for high load transmission may be wound around a variable speed pulley of a belt-type continuously variable transmission.

This structure provides a V-belt for high load transmission efficiently exhibiting the advantages of the present disclosure.

According to the present disclosure, the area S1 of the sliding surface of the tension band of the V-belt for high load transmission and the area S2 of the sliding surface of each of the blocks satisfy the relationship of S1/S2≦0.2. This reduces the temporal change in the belt tension from the initial running stage of the belt according to a change in the thrust-tension conversion ratio. As a result, the thrust of the drive unit decreases to reduce the initial heat built-up of the belt, and to improve the efficiency and the durability of the belt.

### BRIEF DESCRIPTION OF THE DRAWINGS

FIG. 1 is a perspective view of a V-belt for high load transmission according to an embodiment of the present disclosure.

FIG. 2 is a side view of the V-belt for high load transmission.

FIG. 3 is a cross-sectional view taken along the line III-III of FIG. 2.

FIG. 4 is an enlarged side view of a tension band.

FIG. 5 is an enlarged side view of a block.

FIG. 6 is a side view of the V-belt for high load transmission for illustrating the features of the present disclosure.

FIG. 7 illustrates equipment for measuring and testing belt tension.

FIG. 8 illustrates equipment for testing high-speed durability.

FIG. 9 illustrates equipment for measuring and testing belt efficiency.

FIG. 10 illustrates a first half of test results of examples and comparative examples.

FIG. 11 illustrates the other half of the test results of the examples and the comparative examples.

FIG. 12 illustrates the relationship between the ratio of the area of a sliding surface of the tension band to the area of a sliding surface of each block and a change in the belt tension (i.e., inter-shaft power) in each of the examples and the comparative examples.

FIG. 13 illustrates the relationship between the ratio of the area of the sliding surface of the tension band to the area of the sliding surface of each block and high-speed durability in each of the examples and the comparative examples.

FIG. 14 illustrates the relationship between the ratio of the area of the sliding surface of the tension band to the area of the sliding surface of each block and an initial heating temperature in each of the examples and the comparative examples.

FIG. 15 illustrates the relationship between the ratio of the area of the sliding surface of the tension band to the area of the sliding surface of each block and a change in a fastening margin in each of the examples and the comparative examples.

FIG. 16 illustrates the relationship between the ratio of the area of the sliding surface of the tension band to the area of the sliding surface of each block and belt efficiency in each of the examples and the comparative examples.

### DETAILED DESCRIPTION

An embodiment of the present disclosure will be described hereinafter in detail with reference to the drawings. The following description of the preferred embodiment is intrinsically a mere example, and is not intended to limit the present disclosure, equivalents, and application.

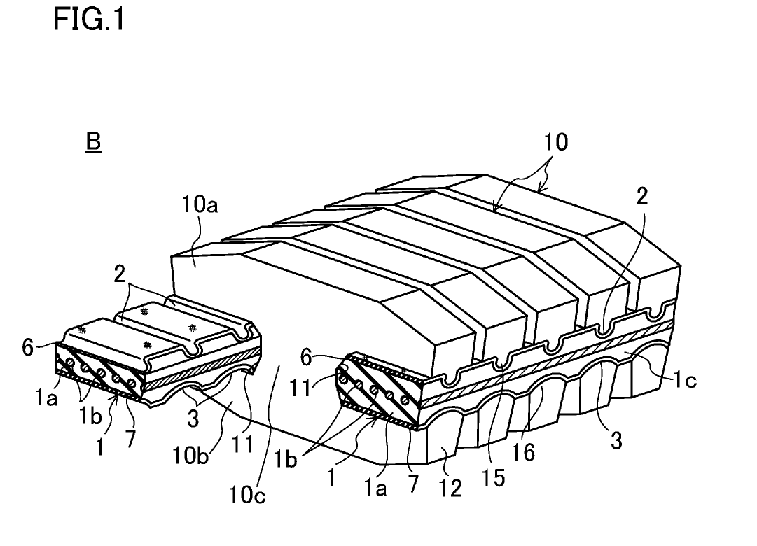

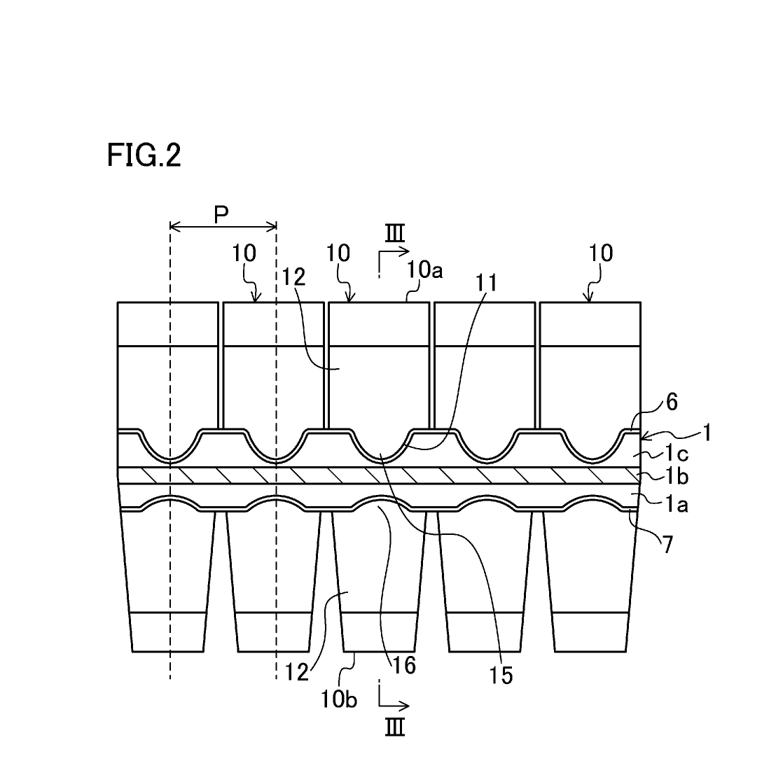

FIGS. 1-3 illustrate a V-belt B for high load transmission according to an embodiment of the present disclosure. Although not shown, this belt B is wound around a plurality of variable speed pulleys of, for example, a belt-type continuously variable transmission. The belt B includes a pair of endless tension bands 1 and 1, and numbers of blocks 10, 10, . . . engaged with and fixed to these tension bands 1 and 1 at a constant pitch P in the belt length direction.

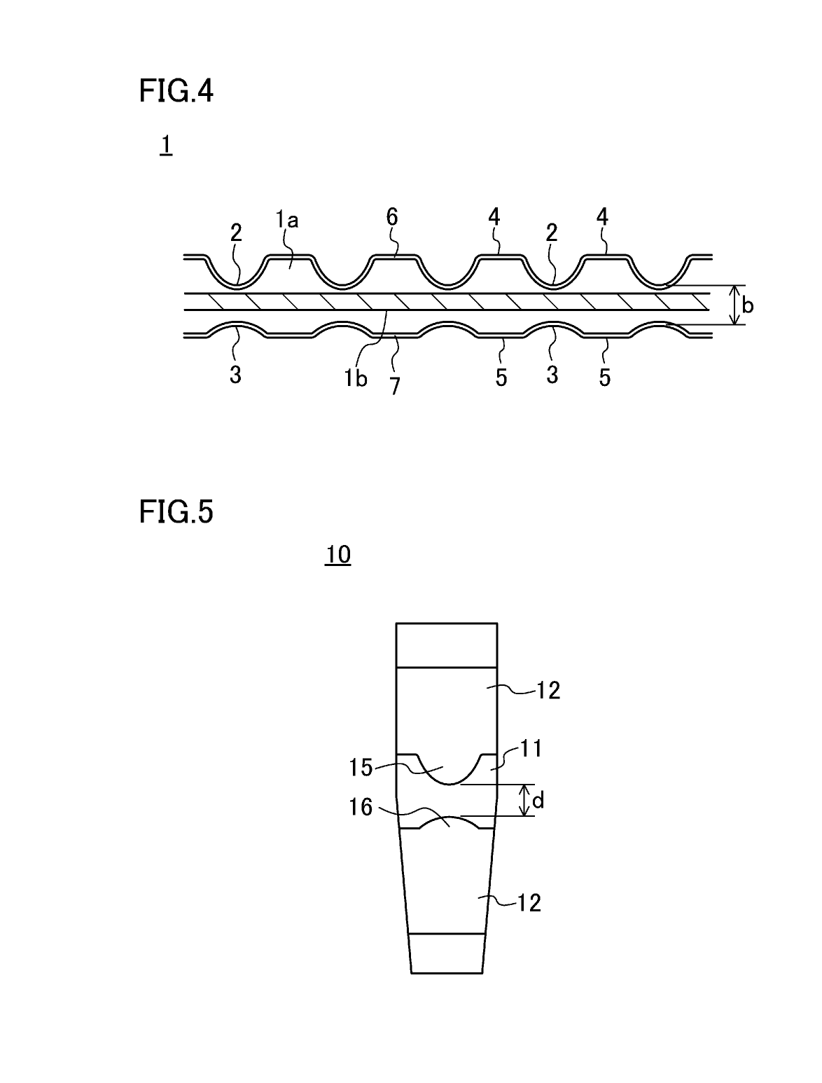

As also shown in FIG. 4, each of the tension bands 1 is formed by burying a plurality of cords (core bodies) 1b, 1b, . . . , which are made of a high-strength, high-elastic modulus material such as aramid fibers, in spiral inside a shape-retaining rubber layer 1a made of hard rubber. In the upper surface of each tension band 1, upper groove-like recesses 2, 2, . . . extending in the belt width direction at a constant pitch are formed as upper grooves to correspond to the blocks 10. In the lower surface, lower recesses 3, 3, . . . extending in the belt width direction at a constant pitch are formed as lower grooves to correspond to the upper recesses 2, 2, . . . . In the upper surface of each tension band 1, an upper cog 4 is formed between each pair of the upper recesses 2, 2, . . . . In the lower surface of each tension band 1, a lower cog 5 is formed between each pair of the lower recesses 3, 3, . . . .

The hard rubber of the shape-retaining rubber layer 1a is formed by reinforcing H-NBR rubber reinforced by, for example, zinc methacrylate, using short fibers such as aramid fibers and nylon fibers. Thus, the hard rubber highly heat resistive and less subject to permanent deformation is used. The hard rubber needs to have a hardness of 75° or higher when measured with a JIS-C hardness meter.

Upper and lower canvas layers 6 and 7 are formed on the upper and lower surfaces of each tension band 1 by integrally adhering canvases, which have been subjected to glue rubber processing.

On the other hand, as shown in FIGS. 1, 3, and 5, each block 10 is formed by burying a reinforcing member 18 in hard resin such as phenolic resin, which is reinforced by, for example, short carbon fibers, to be located in a substantially middle of the block 10. The reinforcing member 18 is, for example, a light aluminum alloy which is a material having higher elastic modulus than the hard resin. Each block 10 is in a substantially H-shape including upper and lower beams 10a and 10b extending in the belt width direction (i.e., the right-left direction), and a pillar 10c vertically connecting the centers of the right and left sides of the both beams 10a and 10b. The blocks 10 have cutout slit-like fit portions 11 and 11, in which each tension band 1 is detachably fitted from the width direction, between the upper and lower beams 10a and 10b of the blocks 10. The right and left side surfaces except for the fit portions 11 are contact sections 12 and 12 abutting on the groove surface of a pulley (not shown) such as a variable speed pulley. The belt angle a between the right and left contact sections 12 and 12 of the blocks 10 is equal to the angle of the groove surface of the pulley. As such, each block 10 includes the hard resin portion forming the periphery of the fit portions 11 and the contact sections 12 and 12, and the reinforcing member 18 forming the other portions. The reinforcing member 18 should not appear on the surfaces of the blocks 10 at the periphery of the fit portions 11 and the contact sections 12 and 12 of the right and left side surfaces. In other portions, the reinforcing member 18 may be exposed to the surfaces of the blocks 10.

The blocks 10 are fixed to the tension bands 1 and 1 by press-fitting the tension bands 1 and 1 in the fit portions 11 and 11. Specifically, as shown in FIG. 5, an upper projection 15 is formed, in the upper wall of the fit portion 11 of each block 10, as an upper tooth meshing with the corresponding upper recess 2 in the upper surface of each tension band 1. A lower projection 16 is formed, in the lower wall of the fit portion 11, as a lower tooth meshing with the corresponding lower recess 3 in the lower surface of the tension band 1. The upper projections 15 are arranged in parallel to the lower projections 16. The upper and lower projections 15 and 16 of the blocks 10 mesh with the upper and lower recesses 2 and 3 of the tension bands 1, thereby engaging and fixing the blocks 10, 10, . . . to the tension bands 1 and 1 in the belt length direction by press-fitting.

A meshing thickness b of each tension band is slightly greater than a meshing thickness d of each block (b>d). The meshing thickness b is the thickness of each tension band 1 made of the hard rubber between the upper and lower recesses 2 and 3, that is, as shown in FIG. 4, the distance between the bottoms of the upper recesses 2 (specifically, the upper surface of the upper canvas layer 6) and the bottoms of the lower recesses 3 (specifically, the lower surface of the lower canvas layer 7) corresponding to the upper recesses 2. The meshing thickness d of is the thickness of the meshing gap of each block 10, that is, as shown in FIG. 5, the distance between the lower end of the upper projection 15 and the upper end of the lower projection 16 of the block 10. As a result, when the blocks 10 are attached to the tension bands 1, the tension bands 1 are compressed by the blocks 10 in the thickness direction, thereby providing a fastening margin b-d (>0).

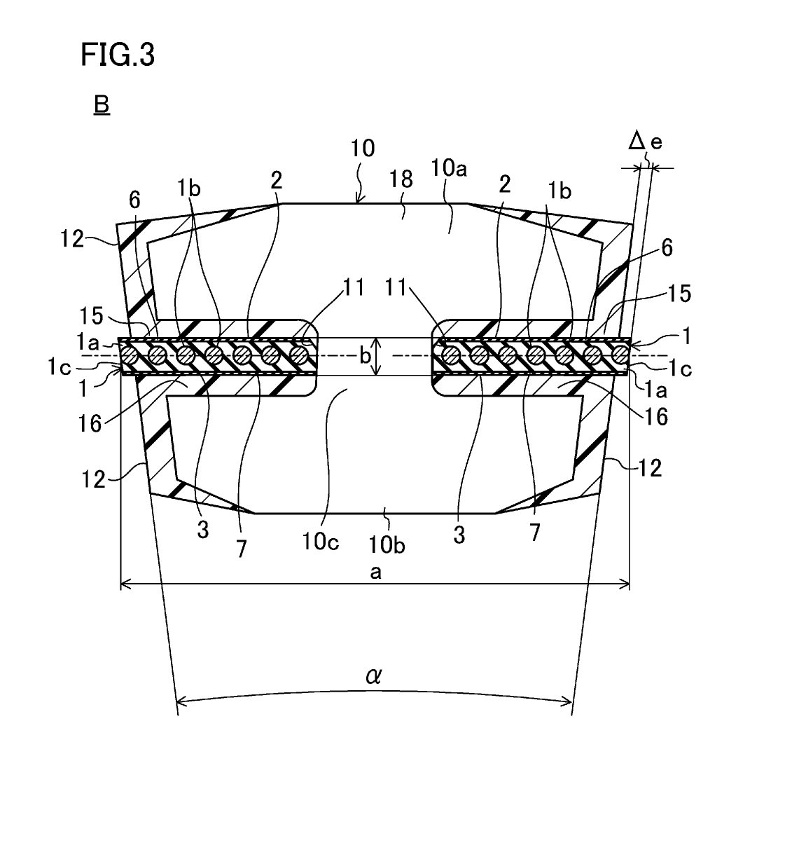

As shown in FIG. 3, with the blocks 10, 10, . . . attached to the tension bands 1 and 1, the outer end surface of each tension band 1 slightly protrudes beyond the sliding surfaces 12, 12 of the blocks 10 at the both right and left side surfaces of the belt B, thereby providing protruding margins Δe. When the belt B is wound around the pulley, the protruding margins Δe of the tension bands 1 and 1 are pushed inside in the belt width direction so that the tension bands 1 and 1 vertically expand inside the fit portions 11. As a result, the blocks 10, 10, . . . are firmly held by the tension bands 1 and 1. Therefore, the outer end surfaces of the both tension bands 1 and 1 are sliding surfaces 1c, 1c abutting on the groove surface of the variable speed pulley, etc.

When this V-belt B for high load transmission is wound around the pulley to run, the upper and lower projections (i.e., the teeth) 15 and 16 of the blocks 10 mesh with the upper and lower recesses (i.e., the grooves) 2 and 3 of the tension bands 1, thereby transmitting power.

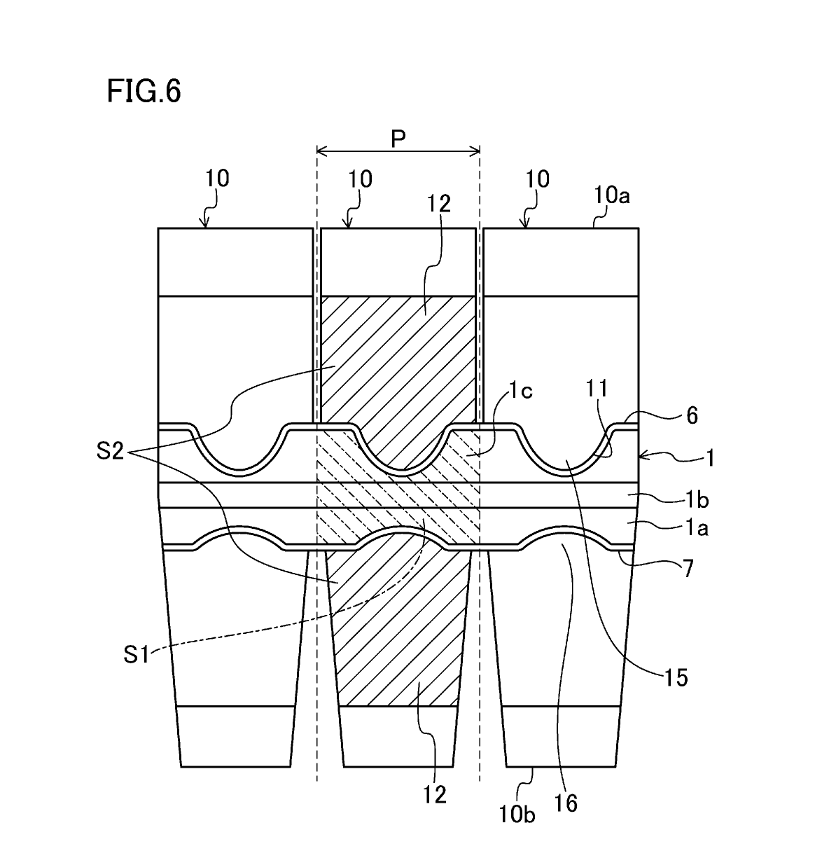

In this V-belt B for high load transmission, in order to reduce the change in the thrust-tension conversion ratio with the running time of the belt, as shown in FIG. 6, the area S1 (hatched by dashed-dotted lines in FIG. 6) of the sliding surface 1c of the tension band 1 and the area S2 (hatched by solid lines in FIG. 6) of the sliding surface 12 of each block 10 satisfy the following relationship.

S1/S2≦0.2 (1)

That is, the area S1 of the sliding surface 1c of each tension band is 20% or smaller of the area S2 of the sliding surface 12 of each block. Specifically, the ratio S1/S2 preferably ranges from 0.13 to 0.2. For example, the area S1 of the sliding surface 1c of each tension band preferably ranges from 4.3 to 8.5 mm², and the area S2 of the sliding surface 12 of each block preferably ranges from 33 to 43 mm².

As shown in FIG. 3, in this embodiment, assume that the belt pitch width a is the belt width of each tension band 1 at the position of the cord 1b in each block 10. The belt pitch width a and the meshing thickness b of each tension band (i.e., the thickness between the bottoms of the upper recesses 2 and the bottoms of the lower recesses 3, see FIG. 4) satisfy the following relationship.

b/a≦0.08 (2)

That is, the meshing thickness b of each tension band is 8% or smaller of the belt pitch width a. A more preferable relationship is as follows.

b/a≦0.05 (3)

(That is, the meshing thickness b of each tension band is 5% or smaller of the belt pitch width a.)

The belt pitch width a is related to the holding area of the tension band 1 holding the blocks 10. Thus, in addition to reducing the meshing thickness b of each tension band, the meshing thickness b of each tension band and the belt pitch width a need to satisfy the above expression (1) or (2).

This V-belt B for high load transmission has the above-described structure. The effects and advantages of this V-belt B for high load transmission will be described next. In this V-belt B for high load transmission, the area S1 of the sliding surface of the each tension band and the area S2 of the sliding surface of each block satisfy the relationship of S1/S2≦0.2. That is, the ratio of the tension band 1 to the contact surface of the belt B with the pulley is sufficiently small. This reduces push-up of the upper beams 10a of the blocks 10 caused by the thermal expansion of the tension band 1, and an increase in the coefficient of friction of the belt, when the belt B is wound around a variable speed pulley of, for example, a continuously variable transmission to run. Thus, the change in the thrust-tension conversion ratio, and the change in the belt tension according thereto are reduced, even after the running time of the belt B has passed. This reduces the thrust (i.e., the thrust pushing a movable sheave of the variable speed pulley in the axis direction) of a drive unit, which opens and closes the variable speed pulley of the transmission to change the gear ratio. As a result, the initial heat built-up of the belt B decreases, and the efficiency and the durability of the belt B improve.

Since the belt pitch width a and the meshing thickness b of each tension band satisfy the relationship of b/a≦0.08, the meshing thickness b of each tension band is sufficiently small relative to the belt pitch width a, thereby reducing bending loss of the belt B. This further reduces the change in the thrust-tension conversion ratio with the running time of the belt B. Where the belt pitch width a and the meshing thickness b of each tension band satisfy the relationship of b/a≦0.05, the change in the thrust-tension conversion ratio with the running time of the belt B decreases more effectively.

### Other Embodiments

In this embodiment, the reinforcing member 18 is inserted into each block. In the present disclosure, however, the entire blocks may be made of resin without using the reinforcing member 18. This structure provides similar effects and advantages.

The V-belt B for high load transmission according to this embodiment is not only wound around the variable speed pulley of the belt-type continuously variable transmission, but may be used for belt-type transmissions including a constant speed pulley (i.e., a V pulley).

### EXAMPLES

Next, specifically conducted examples will be described. V-belts for high load transmission having the structure of the above-described embodiment are fabricated as first to sixth examples and first to third comparative examples. The belt angle α of each belt (i.e., the angle between the sliding sections of the side surfaces of each block) is 26°. The belt pitch width a is 25 mm. The pitch P of the blocks in the belt length direction is 3 mm. The thickness of each block (i.e., the thickness in the belt length direction) is 2.95 mm. Each protruding margin Δe ranges from 0.05 to 0.15 mm. The belt length is 612 mm.

Each used block is formed by inserting and molding a reinforcing member made of a high-strength light aluminum alloy with a thickness 2 mm into phenolic resin. Blocks, which are entirely made of resin without using the reinforcing member made of the aluminum alloy, provide similar advantages.

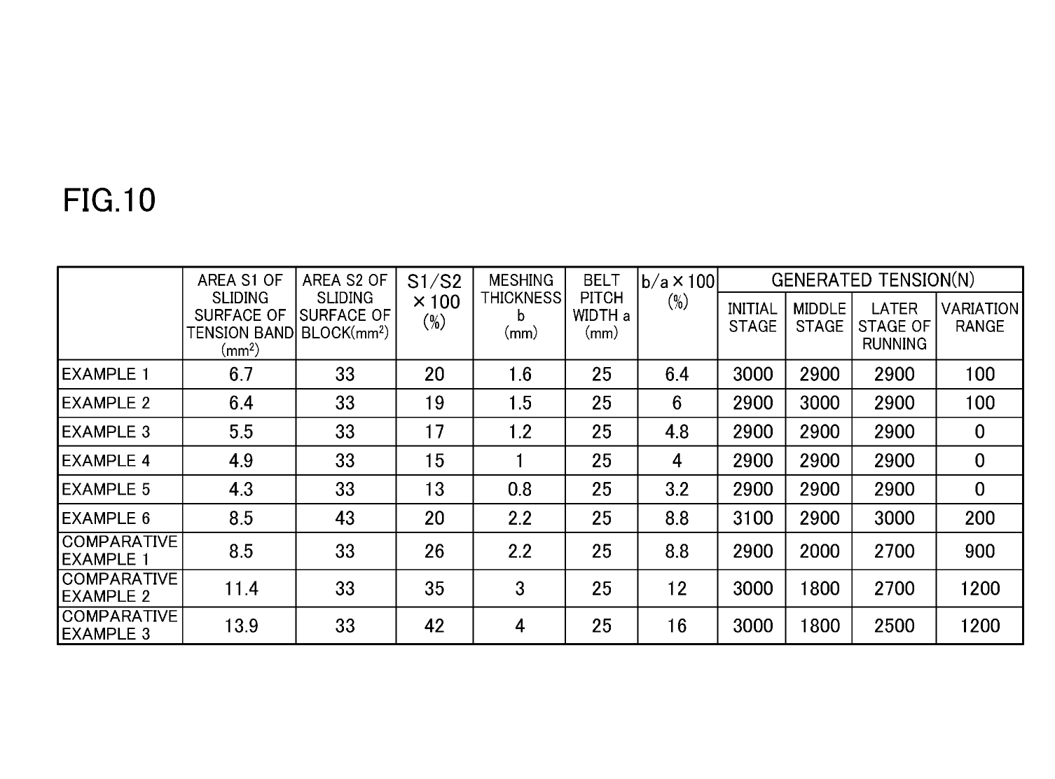

The belts according to the first to sixth examples and the first to third comparative examples have different areas S1 of the sliding surfaces 1c of the tension bands, different areas S2 of the sliding surfaces 12 of the blocks, and different meshing thicknesses b of the tension bands (see FIG. 10).

### First Example

The area S1 of the sliding surface 1c of each tension band is 6.7 mm². The area S2 of the sliding surface 12 of each block is 33 mm². The meshing thickness b of each tension band is 1.6 mm. Therefore, the S1/S2 is 0.20 (i.e., 20%), and b/a is 0.064 (i.e., 6.4%).

### Second Example

The area S1 of the sliding surface 1c of each tension band is 6.4 mm². The area S2 of the sliding surface 12 of each block is 33 mm². The meshing thickness b of each tension band is 1.5 mm. Therefore, S1/S2 is 0.19 (i.e., 19%), and b/a is 0.060 (i.e., 6.0%).

### Third Example

The area S1 of the sliding surface 1c of each tension band is 5.5 mm². The area S2 of the sliding surface 12 of each block is 33 mm². The meshing thickness b of each tension band is 1.2 mm. Therefore, S1/S2 is 0.17 (i.e., 17%), and b/a is 0.048 (i.e., 4.8%).

### Fourth Example

The area S1 of the sliding surface 1c of each tension band is 4.9 mm². The area S2 of the sliding surface 12 of each block is 33 mm². The meshing thickness b of each tension band is 1 mm. Therefore, S1/S2 is 0.15 (i.e., 15%), and b/a is 0.040 (i.e., 4.0%).

### Fifth Example

The area S1 of the sliding surface 1c of each tension band is 4.3 mm². The area S2 of the sliding surface 12 of each block is 33 mm². The meshing thickness b of each tension band is 0.8 mm. Therefore, S1/S2 is 0.13 (i.e., 13%), and b/a is 0.032 (i.e., 3.2%).

### Sixth Example

The area S1 of the sliding surface 1c of each tension band is 8.5 mm². The area S2 of the sliding surface 12 of each block is 43 mm². The meshing thickness b of each tension band is 2.2 mm. Therefore, S1/S2 is 0.20 (i.e., 20%), and b/a is 0.088 (i.e., 8.8%).

### First Comparative Example

The area S1 of the sliding surface 1c of each tension band is 8.5 mm². The area S2 of the sliding surface 12 of each block is 33 mm². The meshing thickness b of each tension band is 2.2 mm. Therefore, S1/S2 is 0.26 (i.e., 26%), and b/a is 0.088 (i.e., 8.8%).

### Second Comparative Example

The area S1 of the sliding surface 1c of each tension band is 11.4 mm². The area S2 of the sliding surface 12 of each block is 33 mm². The meshing thickness b of each tension band is 3 mm. Therefore, S1/S2 is 0.35 (i.e., 35%), and b/a is 0.12 (i.e., 12%).

### Third Comparative Example

The area S1 of the sliding surface 1c of each tension band is 13.9 mm². The area S2 of the sliding surface 12 of each block is 33 mm². The meshing thickness b of each tension band is 4 mm. Therefore, S1/S2 is 0.42 (i.e., 42%), and b/a is 0.16 (i.e., 16%).

### Evaluation of Belt

The temporal change in the belt tension, the high-speed durability, the initial heat built-up, the change in the fastening margin, and belt efficiency are evaluated in each of the above-described examples and comparative examples.

### (1) Temporal Change in Belt Tension

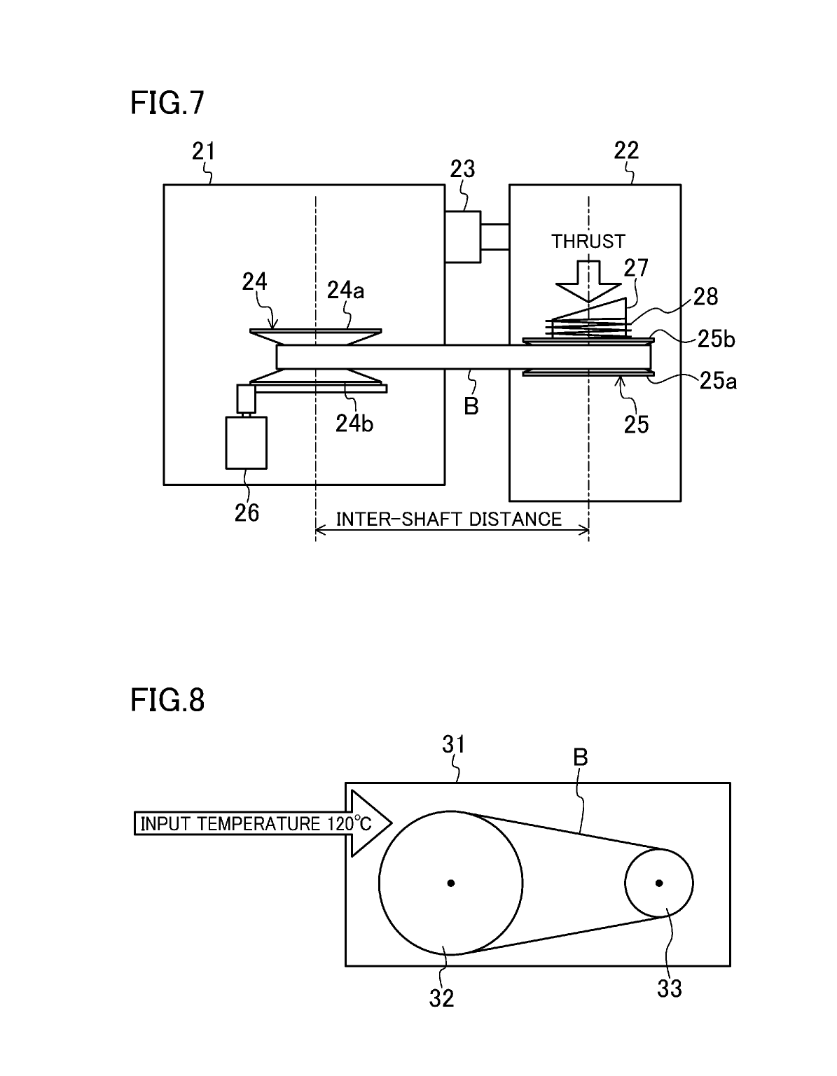

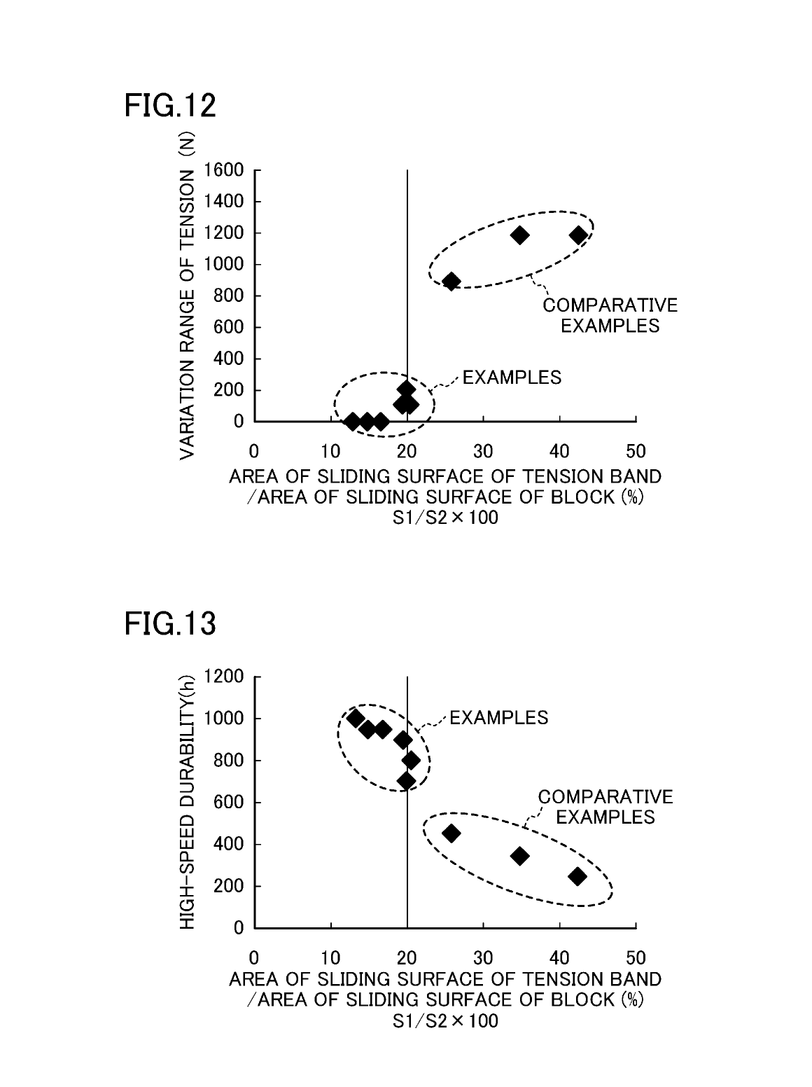

The temporal change in the belt tension was measured in each of the examples and the comparative examples using equipment measuring and testing the belt tension (i.e., inter-shaft power) shown in FIG. 7. Specifically, a drive base 21 and a driven base 22, which move close to and away from each other, pivotally support drive and driven pulleys 24 and 25, which are variable speed pulleys including fixed and movable sheaves 24a, 24b, 25a, and 25b, respectively. The drive base 21 and the driven base 22 were connected via a load cell 23, thereby fixing the inter-shaft distance between the drive and driven pulleys 24 and 25 to 148.5 mm. The drive pulley 24 was drivingly connected to a drive motor 26. The driven pulley 25 was drivingly connected to a load DC motor (not shown) and applied with a constant load torque of 60 N·m. The V-belt B for high load transmission of each of the examples and the comparative examples was wound around the drive and driven pulleys 24 and 25. The speed ratio was fixed to 1.8. A torque cam 27 and a spring 28 applied thrust to the movable sheave 25b of the driven pulley 25 in the axis direction toward the fixed sheave 25a. In this state, the drive motor 26 rotated the drive pulley 24 at a constant speed of 3000 rpm to run the belt B. The inter-shaft power detected by the load cell 23 during the run was measured as the belt tension. The temporal change in the belt tension was obtained from the measurement values at an initial running stage (i.e., 0-24 hours after the start of running) of the belt B, at a middle stage (i.e., 24-48 hours after the start of running), and in a later stage (i.e., 48 or more hours after the start of running), which is represented by a stable measurement value. The temperature of each belt B was 120° C. FIGS. 10 and 12 show the results.

### (2) High-Speed Durability

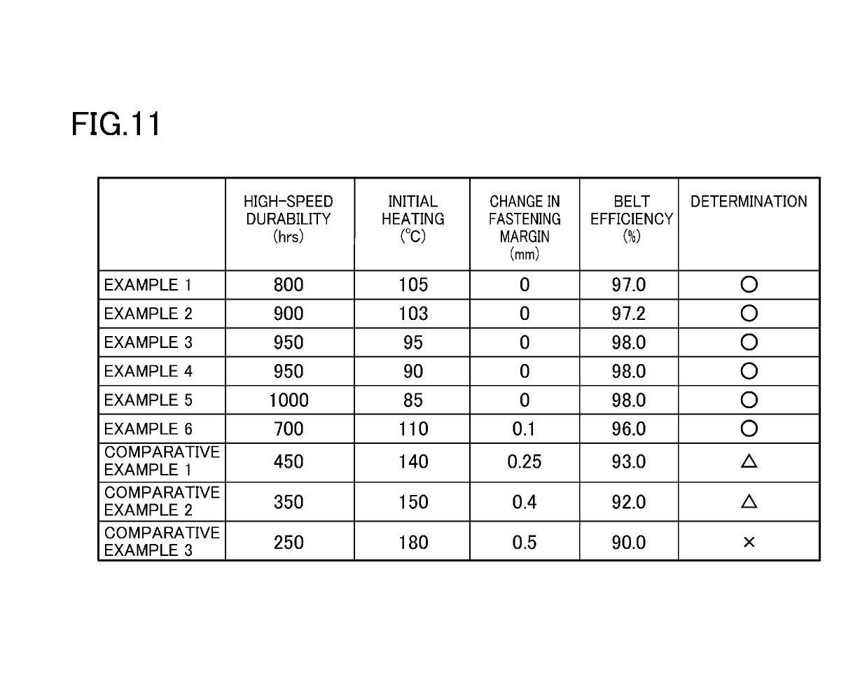

The high-speed, high-load durability and the heat resistance were measured in each of the examples and the comparative examples using equipment for testing high-speed durability shown in FIG. 8. Specifically, a drive pulley 32, which is a constant speed pulley with a pitch size of 133.6 mm and a driven pulley 33, which is a constant speed pulley with a pitch size of 61.4 mm, were provided in a test box 31, to which an atmosphere at 120° C. was input as heat capacity. The belt B of each of the examples and the comparative examples was wound around the both pulleys 32 and 33. The drive pulley 32, which rotated with a shaft torque of 63.7 N·m at a high speed of 5016±60 rpm, was measured for 300 hours. FIGS. 11 and 13 show the results.

### (3) Initial Heat Built-Up

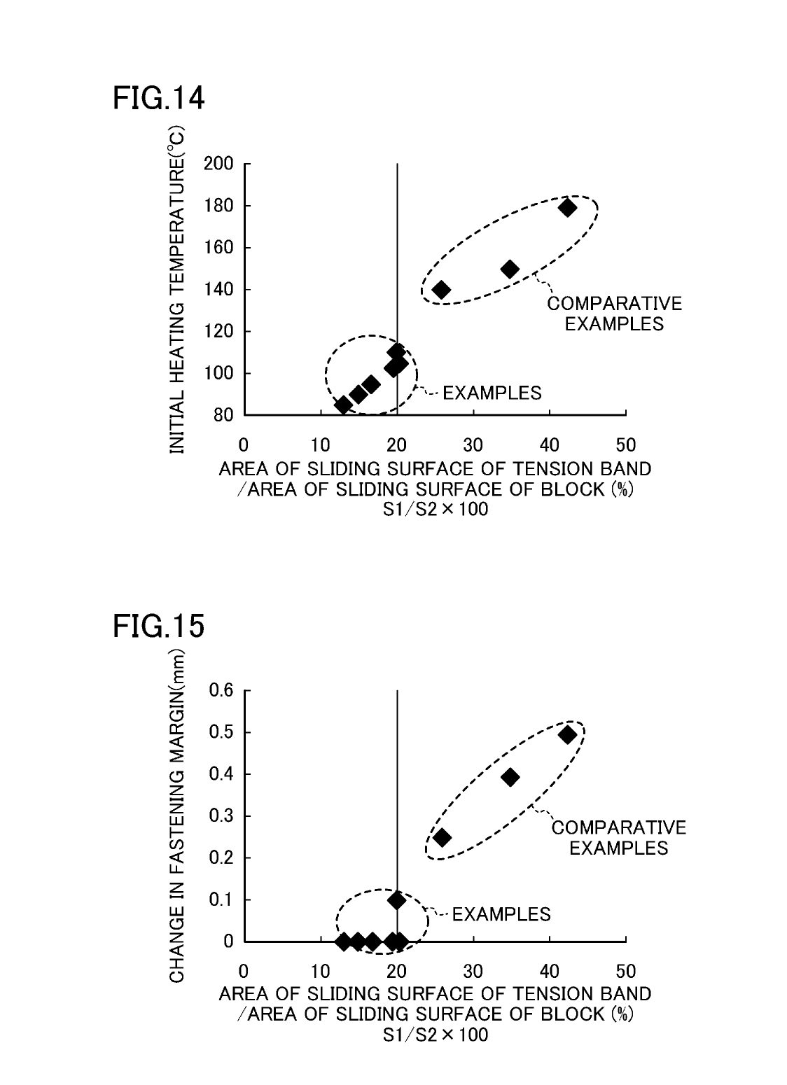

At the test of the high-speed, high-load durability and the heat resistance, the heating temperature of each belt B at the initial running stage (2hours after the start of running) was measured. FIGS. 11 and 14 show the results.

### (4) Change in Fastening Margin

At the test of the high-speed, high-load durability and the heat resistance, the change in the fastening margin after 250 hours has passed after the start of running was measured. The fastening margin was obtained by subtracting the meshing thickness d of each block from the thickness b of each tension band. FIGS. 11 and 15 show the results.

### (5) Belt Efficiency

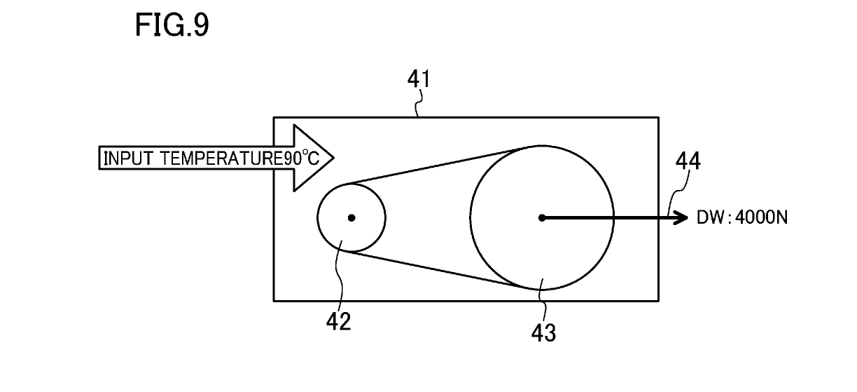

The belt efficiency was measured in the examples and the comparative examples using test equipment shown in FIG. 9. Specifically, a drive pulley 42, which is a constant speed pulley with a pitch size of 65.0 mm, and a driven pulley 43, which is a constant speed pulley with a pitch size of 130.0 mm, were provided to move close to and away from each other in a test box 41, to which an atmosphere at 90° C. was input as heat capacity. The belt B of each of the examples and the comparative examples was wound around the both pulleys 42 and 43. The driven pulley 43 bore a deadweight 44 of 4000 N in the direction away from the drive pulley 42. In this state, the drive pulley 42 rotated at a speed of 2600±60 rpm. The shaft torque of the drive pulley 42 was slowly increased. The slip ratio was continuously obtained from the speed of the drive pulley 42 and the speed of the driven pulley 43. The torque of the drive pulley 42 and the torque of the driven pulley 43 were measured when the slip ratio of each belt B was 2% to obtain the belt efficiency based on the following equation. Where the belt efficiency is η,

efficiency η (%)={(speed of driven pulley×torque of driven pulley)/(speed of drive pulley×torque of drive pulley)}×100

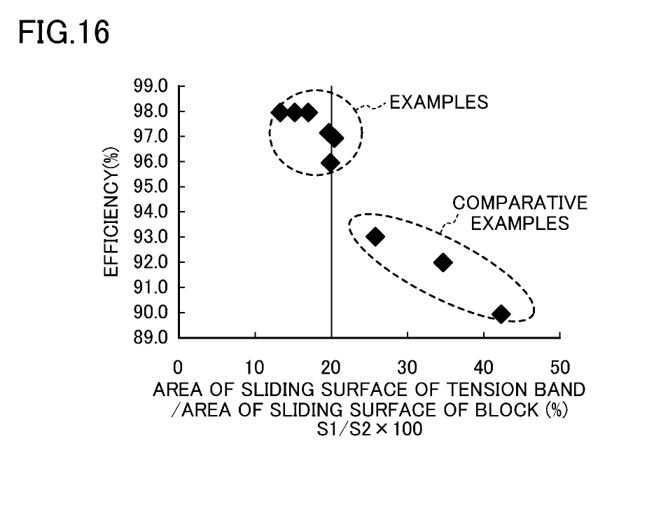

FIGS. 11 and 16 show the results.

In FIG. 11, circles represent good, and triangles and crosses represent bad in the columns of determination.

The above-described results show that, in the first to sixth examples, in which the area S1 of the sliding surface 1c of each tension band is 20% or smaller of the area S2 of the sliding surface 12 of each block, the variation range of the belt tension is 200 N or lower. That is, the temporal change is small. On the other hand, in the first to third comparative examples, the area S1 of the sliding surface 1c of each tension band is greater than 20% of the area S2 of the sliding surface 12 of each block. That is, the variation range of the belt tension is as wide as 900 N or more. From the foregoing, it is found that a change in the thrust-tension conversion ratio with the running time of the belt is reduced by setting the area S1 of the sliding surface 1c of each tension band to be 20% or smaller of the area S2 of the sliding surface 12 of each block.

In the first to sixth examples, the area S1 of the sliding surface 1c of each tension band is 20% or smaller of the area S2 of the sliding surface 12 of each block. These examples clearly show that the high-speed durability, the initial heat built-up, the change in the fastening margin, and the belt efficiency dramatically improve. These examples are significantly distinguishable from the first to third comparative examples.

Furthermore, in the first to fifth examples in which the meshing thickness b of each tension band is 8% or smaller of the belt pitch width a, the variation range of the belt tension is 100 N or narrower. In particular, in the third to fifth examples in which the meshing thickness b of each tension band is 5% or smaller of the belt pitch width a, the variation range of the belt tension is 0 N. That is, there is no temporal change. From the foregoing, it is found that the change in the thrust-tension conversion ratio with the running time of the belt is reduced by setting the meshing thickness b of each tension band to be 8% or smaller of the belt pitch width a.

As compared to conventional art, the present disclosure reduces the temporal change in the tension in running the belt, and provides dramatically high performance such as heat built-up, running durability, and belt efficiency. Therefore, the present disclosure is significantly useful and is highly industrially applicable in utilizing for belts of continuously variable transmissions such as vehicles and two-wheel scooters.

What is claimed is:

1. A V-belt for high load transmission comprising:
tension bands, each including
a cord buried inside a shape-retaining rubber layer, and
numbers of upper and lower grooves arranged in a belt length direction to vertically correspond to each other, the upper grooves being formed in an upper surface facing a back of the belt, and the lower grooves being formed in a lower surface facing a bottom of the belt; and
numbers of blocks, each including
fit portions in which the tension bands are press-fitted,
an upper tooth formed in upper surfaces of the fit portions and meshing with the upper grooves of the tension bands, and
a lower tooth formed in lower surfaces of the fit portions and meshing with the lower grooves of the tension bands, wherein
the tension bands are fitted in the fit portions of the blocks, thereby engaging and fixing the blocks with and to the tension bands,
meshing of the teeth of the blocks with the grooves of the tension bands transmits power,
side surfaces of each tension band and the blocks in a belt width direction form sliding surfaces abutting on a groove surface of a pulley, and
an area S1 of the sliding surface of the tension band and an area S2 of the sliding surface of each of the blocks satisfy a relationship of S1/S2≦0.2.

2. The V-belt for high load transmission of claim 1, wherein
a ratio S1/S2 of the area S1 of the sliding surface of the tension band to the area S2 of the sliding surface of each of the blocks ranges from 0.13 to 0.2.

3. The V-belt for high load transmission of claim 1, wherein
a belt pitch width a being a belt width at a position of the cord of each tension band, and a meshing thickness b of the tension band between lower ends of the upper grooves and upper ends of the lower grooves satisfy a relationship of b/a≦0.08.

4. The V-belt for high load transmission of claim 2, wherein
a belt pitch width a being a belt width at a position of the cord of each tension band, and a meshing thickness b of the tension band between lower ends of the upper grooves and upper ends of the lower grooves satisfy a relationship of b/a≦0.08.

5. The V-belt for high load transmission of claim 3, wherein
the belt pitch width a and the meshing thickness b of the tension band satisfy a relationship of b/a≦0.05.

6. The V-belt for high load transmission of claim 4, wherein the belt pitch width a and the meshing thickness b of the tension band satisfy a relationship of b/a≦0.05.

7. The V-belt for high load transmission of claim 1, wherein the area S1 of the sliding surface of the tension band ranges from 4.3 to 8.5 mm².

8. The V-belt for high load transmission of claim 1, wherein
the area S2 of the sliding surface of each of the blocks ranges from 33 to 43 mm².

9. The V-belt for high load transmission of claim 1 is wound around a variable speed pulley of a belt-type continuously variable transmission.
